(19) United States
(12) Patent Application Publication
(10) Pub. No.: US 2010/0278315 A1
(43) Pub. Date: Nov. 4, 2010

(54) METHOD AND APPARATUS FOR DISSEMENATING INFORMATION RELATING TO A LOCAL EMERGENCY CONDITION

(76) Inventors: Stuart O. Goldman, Scottsdale, AZ (US); Karl F. Rauscher, Emmaus, PA (US)

Correspondence Address: FAY SHARPE/LUCENT, 1228 Euclid Avenue, 5th Floor, The Halle Building, Cleveland, OH, 44115-1843, US

(21) Appl. No.: 12/638,238

(22) Filed: Dec. 15, 2009

Related U.S. Application Data
(60) Provisional application No. 61/215,298, filed on May 4, 2009.

(51) Int. Cl. H04M 11/04

(52) U.S. Cl. 379/45

(57) ABSTRACT

A method for disseminating information relating to a local emergency condition includes providing a user device with access to an outgoing announcement via a network node in a communication network, the outgoing announcement accessible via a non-emergency network address for a destination device of an information service organization that provides information service relating to local emergency conditions for a geographic area, the outgoing announcement providing information for a local emergency condition within the geographic area; receiving an incoming call originated by the user device and directed to the non-emergency network address, the network node and the user device being located within the predetermined geographic area; connecting the incoming call to the destination device; and routing the outgoing announcement from the destination device to the user device through the network node. A network node associated with the method may include an input module, a handling module, and an output module.

### CROSS-REFERENCE TO RELATED APPLICATIONS

This application claims the right of priority and any benefit associated with, U.S. Provisional Pat. App. Ser. No. 61/215,298, filed May 4, 2009, the entire contents of which are fully incorporated herein by reference.

### BACKGROUND

This disclosure relates to a method and apparatus for disseminating information relating to a local emergency condition to originators of incoming calls to an information service organization. For example, this disclosure describes exemplary embodiments for providing the incoming call originator with status and guidance information relating to the local emergency condition. This provides an alternative for originators of incoming calls to an emergency response organization that are merely seeking status and guidance information rather than specific emergency response services.

By way of background, citizens need to be able to get up-to-date local information when there is an emergency event, such as a flu pandemic, chemical spill, flood, etc. Normally, citizens have a number of communication options to obtain local information (e.g., TV, radio, the Internet), but additional alternatives are needed, especially for mobile citizens that only have access to such information via a wireless device.

In the United States, service access codes (SACs) are often used for commonly placed calls. For example, a 911 call (112 call in the European Union) for local emergency response services is the most widely known and used SAC. Another example of an SAC in the United States is 511, which is considered a traveler information number. The Federal Communications Commission (FCC) designated 511 as the traffic information SAC for use by states and local jurisdictions on Jul. 21, 2000. Since then, at least 27 states have launched 511 services to benefit local travelers. Traveler information systems, such as 511 services, help reduce travel times, decrease fuel consumption, and reduce the number of accidents, all acting to benefit regional economies. They even help cut down on vehicle emissions, thereby improving air quality. Eventually, the 511 SAC should be available nationwide.

In the absence of other mechanisms, some citizens may call an emergency response organization (e.g., 911 calls in the United States, 112 calls in the European Union) to inquire about the current status of an emergency event. This may tie up scarce resources at the emergency response organization (e.g., public safety answering point (PSAP)) and can prevent calls for specific emergency response assistance from reaching a call taker for dispatch of an emergency vehicle.

The primary purpose of an incoming call to an emergency response organization (e.g., 911 calls in the United States, 112 calls in the European Union) is to connect an originator of the incoming call with a call taker at the emergency response organization (e.g., PSAP) so that the originator can request assistance for an emergency, such as medical, fire, or rescue emergency. Depending on the nature of the emergency, the call taker focuses on dispatching assistance to the specific call originator.

An incoming call directed to an emergency response organization is normally answered rapidly by a call taker at the emergency response organization. However, during mass events there may be more incoming calls arriving than can be handled by the call takers. First, the incoming calls may be queued up or stored in a call queue or buffer. If even more calls come in that cannot be serviced by call takers, the capacity of the call queue may be exceeded and the calls may either be redirected to an adjacent or alternate emergency response organization or released with reorder tone (e.g., slow busy tone). This is the reality of not having enough call takers in light of the increased demand caused by the mass event or local emergency condition. Obviously, these results do not resolve the emergency situation that caused the originator to initiate the incoming call in the first place.

In the absence of any better guidance, upon getting a reorder tone, the originator may initiate a new incoming call to the emergency response organization. This may be repeated continuously until the originator's need is satisfied or until they give up in frustration without the need being satisfied. In mass emergencies, the originator may be wasting time making such repeated attempts to contact the emergency response organization rather than taking action to avoid or reduce the risk posed by the emergency condition.

Part of the call congestion problem is because there is no procedure in place for separating out calls for general information from calls for specific help, such as the dispatch of an emergency vehicle. Therefore, all calls to the emergency response organization are simply serviced in the order received.

Based on the foregoing, a solution that may reduce incoming call congestion at an emergency response organization is desirable. Additionally, a solution that may reduce the wait time in call queues for incoming calls to the emergency response organization is desirable. Moreover, it may be useful to assign a non-emergency network address, such as a SAC, to provide call originators with general information relating to local emergency conditions. These solutions would allow citizens to make inquires and remain informed about local emergency conditions without contributing to call congestion at an emergency response organization.

### SUMMARY

In one aspect, a method for disseminating information relating to a local emergency condition is provided. In one embodiment, the method includes: a) providing at least a first user device with access to an outgoing announcement via at least a first network node in a communication network, the outgoing announcement accessible via a non-emergency network address associated with a destination device, the non-emergency network address also being associated with an information service organization that provides information service relating to local emergency conditions for a predetermined geographic area, wherein the non-emergency network address is distinct from an emergency network address associated with an emergency response organization that provides emergency response service for at least a portion of the predetermined geographic area, wherein the outgoing announcement provides select information for at least one local emergency condition within at least a portion of the predetermined geographic area; b) receiving a first incoming call at the first network node, the first incoming call originated by the first user device and directed to the non-emergency network address, the first network node and the first user device being located within the predetermined geographic area; c) connecting the first incoming call to the destination device; and d) routing the outgoing announcement from the destination device to the first user device through at least the first network node.

In another aspect, an apparatus for disseminating information relating to a local emergency condition is provided. In one embodiment, the apparatus includes: a first network node in a communication network for providing at least a first user device with access to an outgoing announcement via at least the first network node, the outgoing announcement accessible via a non-emergency network address associated with a destination device, the non-emergency network address also being associated with an information service organization that provides information service relating to local emergency conditions for a predetermined geographic area, wherein the non-emergency network address is distinct from an emergency network address associated with an emergency response organization that provides emergency response service for at least a portion of the predetermined geographic area, wherein the outgoing announcement provides select information for at least one local emergency condition within at least a portion of the predetermined geographic area. In this embodiment, the first network node includes: a first input module for receiving a first incoming call originated by the first user device and directed to the non-emergency network address, the first network node and the first user device being located within the predetermined geographic area; a first handling module in operative communication with the first input module for connecting the first incoming call to the destination device; and a first output module in operative communication with the first handling module for routing the outgoing announcement from the destination device to the first user device through at least the first network node.

In yet another aspect, another method for disseminating information relating to a local emergency condition is provided. In one embodiment, the method includes: a) providing at least first and second user devices with access to an outgoing announcement via at least a first network node in a communication network, the outgoing announcement accessible via a non-emergency network address associated with a destination device, the non-emergency network address also being associated with an information service organization that provides information service relating to local emergency conditions for a predetermined geographic area, wherein the non-emergency network address is distinct from an emergency network address associated with an emergency response organization that provides emergency response service for at least a portion of the predetermined geographic area, wherein the outgoing announcement includes a pre-recorded message having a known duration and the pre-recorded message is iteratively repeated over time, wherein the pre-recorded message provides select information for at least one local emergency condition within at least a portion of the predetermined geographic area; b) receiving a first incoming call at the first network node, the first incoming call originated by the first user device and directed to the non-emergency network address, the first network node and the first user device being located within the predetermined geographic area; c) receiving a second incoming call at the first network node, the second incoming call originated by the second user device and directed to the non-emergency network address, the second user device being located within the predetermined geographic area; d) connecting the first and second incoming calls to the destination device after a current iteration of the pre-recorded message is complete; and e) routing the outgoing announcement from the destination device to the first and second user devices through at least the first network node such that the outgoing announcement begins at a next iteration of the pre-recorded message.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a flow chart of an exemplary embodiment of a process for disseminating information relating to a local emergency;

FIG. 2, in conjunction with FIG. 1, is a flow chart of another exemplary embodiment of a process for disseminating information relating to a local emergency;

FIG. 3, in conjunction with FIG. 1, is a flow chart of yet another exemplary embodiment of a process for disseminating information relating to a local emergency;

FIG. 4 is a block diagram of an exemplary embodiment of a network node in a communication network for disseminating information relating to a local emergency;

FIG. 5 is a block diagram of another exemplary embodiment of a network node in a communication network for disseminating information relating to a local emergency;

FIG. 6 is a block diagram of an exemplary embodiment of a communication network with multiple network nodes for disseminating information relating to a local emergency; and

FIG. 7 is a flow chart of still another exemplary embodiment of a process for disseminating information relating to a local emergency.

### DETAILED DESCRIPTION

Various embodiments of methods and network nodes for disseminating information relating to a local emergency condition (e.g., an event) are disclosed herein. In one embodiment, a non-emergency network address, such as a SAC, is assigned to an information service organization that provides call originators with general information relating to local emergency conditions. This allow citizens to make inquires and remain informed about local emergency conditions without contributing to call congestion at an emergency response organization.

Use of SACs would be applicable for North America and other regions with numbering plans that use SACs. As for geographic SACs, such as N11, there are nine possible SACs which may already be assigned to some specific purpose by government regulatory authorities, such as the FCC. Other three digit patterns may already be assigned for office codes or area codes. There may be no unique SACs available in certain regions, such as in the United States, under the North American Numbering Plan. This may or may not be the case in other regions. However, a solution to extend or change the purpose of an existing SAC could easily benefit such regions.

For example, a modification to the US 511 service (and an equivalent SAC in other regions) so that, when a local emergency condition exists, the announcement placed to 511 callers provides up-to-date local information about the emergency condition and, if the caller remains off hook, the announcement continues to provide traffic information (or additional information assigned to the SAC in the region.)

The mechanisms for updating message content for 511 services are already in place and could be used to create and maintain the portion of the announcement providing information relating to local emergency conditions. For example, the 511 service could provide an announcement that “because of the flu pandemic all professional sports events in Phoenix have been cancelled until May 5. There is no traffic information to report at this time.”

Other examples of “events” can include: i) short term events such as severe weather, plane crashes, chemical spills, building collapses, riots, etc; ii) medium term events such as floods, power outages, etc.; and iii) long term events such as pandemics (e.g., flu), war, civil unrest, etc. The determination and classification of an “event” and the corresponding information to be provided to the public is a matter of local authority policy. The embodiments described herein address the mechanism by which the information can be conveyed to the public. The announcement can be locally recorded by the information service organization under authority of an emergency response organization (e.g., PSAP) and easily changed as the event progresses. Obviously, the embodiments described herein are more likely to reduce message congestion to the emergency response organization, and thereby provide more value, if the announcement is kept current when new information regarding the local emergency condition becomes available.

While traditional telephony terms and equipment may be used herein for the description and examples, the concepts defined herein are equally applicable to all modalities of access in addition to traditional wireline technology. For example, the various embodiments disclosed herein may be implemented using wireline, wireless (e.g., satellite, cellular, WiFi (such as IEEE 802.11), WiMax (such as IEEE 802.16), etc.), text messaging service (e.g., short messaging service (SMS)), e-mail service, internet protocol (IP) communications, voice over IP (VoIP) communications, multimedia communications, and other access methodologies, including future access methodologies. While voice may be used in the description and examples, the concept is equally applicable to text and multimedia formats.

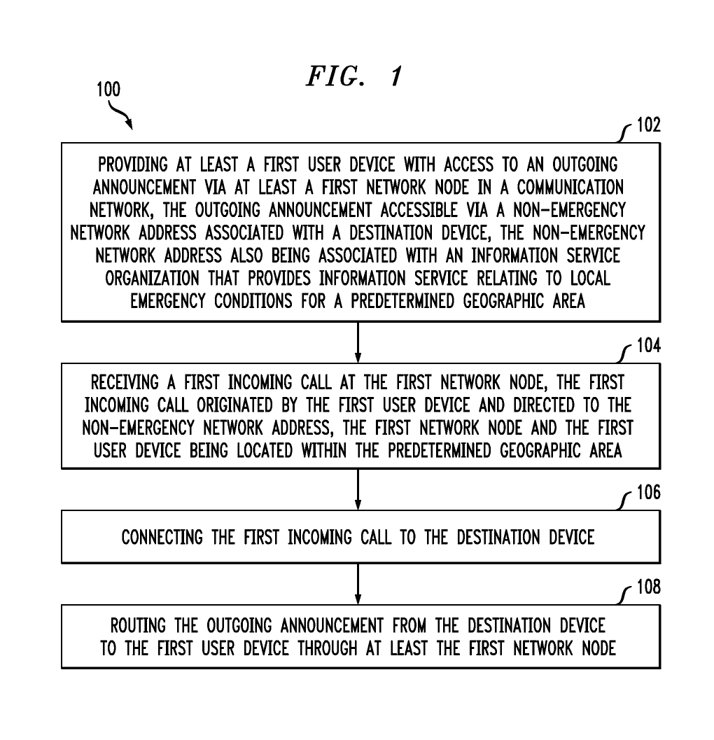

Referring now to the drawings wherein the showings are for purposes of illustrating the exemplary embodiments only and not for purposes of limiting the claimed subject matter, FIG. 1 depicts an exemplary embodiment of a process 100 for disseminating information relating to a local emergency condition that begins at 102 where at least a first user device may be provided with access to an outgoing announcement via at least a first network node in a communication network. The outgoing announcement may be accessible via a non-emergency network address associated with a destination device. The non-emergency network address may also be associated with an information service organization that provides information service relating to local emergency conditions for a predetermined geographic area. The non-emergency network address is distinct from an emergency network address associated with an emergency response organization that provides emergency response service for at least a portion of the predetermined geographic area. For example, the non-emergency network address may be a 511 geographic SAC and the emergency network address may be a 911 geographic SAC. The outgoing announcement may provide select information for at least one local emergency condition within at least a portion of the predetermined geographic area.

At 104, a first incoming call may be received at the first network node. The first incoming call may be originated by the first user device and directed to the non-emergency network address. The first network node and the first user device may be located within the predetermined geographic area. Next, the first incoming call may be connected to the destination device (106). At 108, the outgoing announcement may be routed from the destination device to the first user device through at least the first network node.

In another embodiment of the process 100, the first incoming call may include a voice call, a VoIP call, or any suitable type of call in any suitable combination. In yet another embodiment of the process 100, the first network node may include a circuit switching center, a mobile switching center (MSC), a base station, a packet switching center, an internet service provider (ISP), a VoIP service provider, or any suitable type of network node. Of course, a given network node may include multiple types of network nodes in any suitable combination. For example, in one embodiment, the first network node may include a serving network node serving user devices within at least a portion of the predetermined geographic area.

In still another embodiment of the process 100, the communication network may include a public switched telephone network (PSTN), a wireless telephone network, a cellular telephone network, a satellite telephone network, an IP network, a VoIP network, a local area network (LAN), a wide area network (WAN), a metropolitan area network (MAN), or any suitable type of communication network in any suitable combination.

In still yet another embodiment of the process 100, the first user device may include a landline telephone, a wireless telephone, a cellular telephone, a satellite telephone, a portable computer device, a computer workstation, an IP telephone, or any suitable user device in any suitable combination. In another embodiment of the process 100, the non-emergency network address may include a SAC, a directory number, a telephone number, an IP address, or any suitable network address. Of course, a given network address may include multiple types of network addresses in any suitable combination.

In yet another embodiment of the process 100, the destination device may include an outgoing announcement system, an interactive voice response (IVR) system, an answering machine, a landline telephone, a wireless telephone, a cellular telephone, a satellite telephone, a portable computer device, a computer workstation, an IP telephone, or any suitable destination device in any suitable combination. For example, in one embodiment, the destination device may be located within the first network node.

In still another embodiment of the process 100, the emergency network address may include a SAC, a directory number, a telephone number, an IP address, or any suitable network address. Of course, a given network address may include multiple types of network addresses in any suitable combination. In still yet another embodiment of the process 100, the emergency response organization may include a PSAP, an emergency call center, a law enforcement organization, a fire emergency response organization, a medical emergency response organization, a search emergency response organization, a rescue emergency response organization, a hazardous materials (HAZMAT) emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In another embodiment of the process 100, the information service organization may include a private business entity, a public business entity, a government agency, a government executive organization, or any suitable business or government entity in any suitable combination. In yet another embodiment of the process 100, the select information provided in the outgoing announcement may include a status report for at least one local emergency condition within at least a portion of the predetermined geographic area and a guidance report with at least one response measure for each corresponding local emergency condition. In still another embodiment of the process 100, the outgoing announcement may be periodically updated during each corresponding local emergency condition to provide near real-time select information for each corresponding local emergency condition.

For example, in one embodiment, the outgoing announcement may be periodically updated during each corresponding local emergency condition in conjunction with source information from a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still yet another embodiment of the process 100, the outgoing announcement may be uninterruptible while the first incoming call is connected to the destination device. In another embodiment of the process 100, the outgoing announcement may include a one-way broadcast communication.

In yet another embodiment of the process 100, the outgoing announcement may include a pre-recorded message having a known duration. In the embodiment being described, the process 100 may include repeating 108 until the first incoming call is ended by the first user device. Alternatively, for the embodiment being described, the process 100 may include ending the first incoming call after the pre-recorded message for the outgoing announcement in 108 is complete.

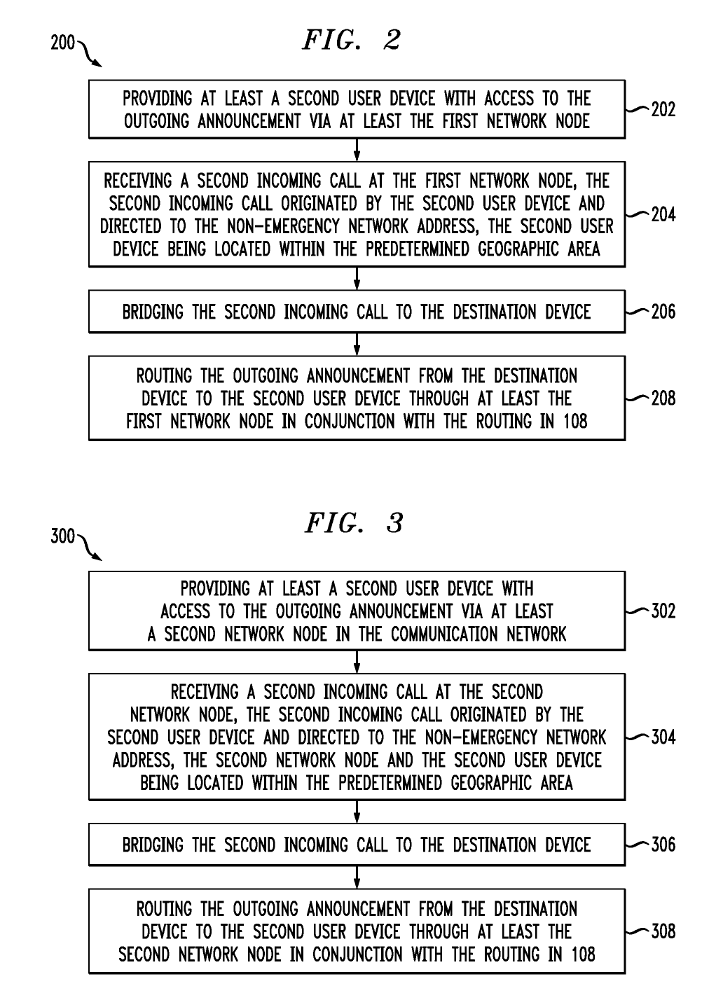

With reference to FIGS. 1 and 2, in another exemplary embodiment of a process 200 for disseminating information relating to a local emergency condition the first network node may provide multiple user devices with access to the outgoing announcement. The process 200 may include 102, 104, 106, and 108 of FIG. 1. The process 200 may also include providing at least a second user device with access to the outgoing announcement via at least the first network node (202). At 204, a second incoming call may be received at the first network node. The second incoming call may be originated by the second user device and directed to the non-emergency network address. The second user device may be located within the predetermined geographic area. Next, the second incoming call may be bridged to the destination device (206). At 208, the outgoing announcement may be routed from the destination device to the second user device through at least the first network node in conjunction with the routing in 108.

With reference to FIGS. 1 and 3, in another exemplary embodiment of a process 200 for disseminating information relating to a local emergency condition first and second network nodes may provide multiple user devices with access to the outgoing announcement. The process 300 may include 102, 104, 106, and 108 of FIG. 1. The process 300 may also include providing at least a second user device with access to the outgoing announcement via at least a second network node in the communication network (302). At 304, a second incoming call may be received at the second network node. The second incoming call may be originated by the second user device and directed to the non-emergency network address. The second network node and the second user device may be located within the predetermined geographic area. Next, the second incoming call may be bridged to the destination device (306). At 308, the outgoing announcement may be routed from the destination device to the second user device through at least the second network node in conjunction with the routing in 108.

With reference again to FIG. 1, in another embodiment of the process 100, the outgoing announcement may include a pre-recorded message having a known duration and the pre-recorded message may be iteratively repeated over time. In the embodiment being described, the connecting in 106 may be after a current iteration of the pre-recorded message is complete such that the outgoing announcement for the routing in 108 begins at a next iteration of the pre-recorded message. In this embodiment, the process 100 may also include providing at least a second user device with access to the outgoing announcement via at least the first network node. In the embodiment being described, a second incoming call may be received at the first network node. The second incoming call may be originated by the second user device and directed to the non-emergency network address. The second user device may be located within the predetermined geographic area. In this embodiment, the second incoming call may be connected to the destination device after the current iteration of the pre-recorded message is complete. Then, the outgoing announcement may be routed from the destination device to the second user device through at least the first network node in conjunction with the routing in 108 such that the outgoing announcement to the first and second user devices begins at the next iteration of the pre-recorded message.

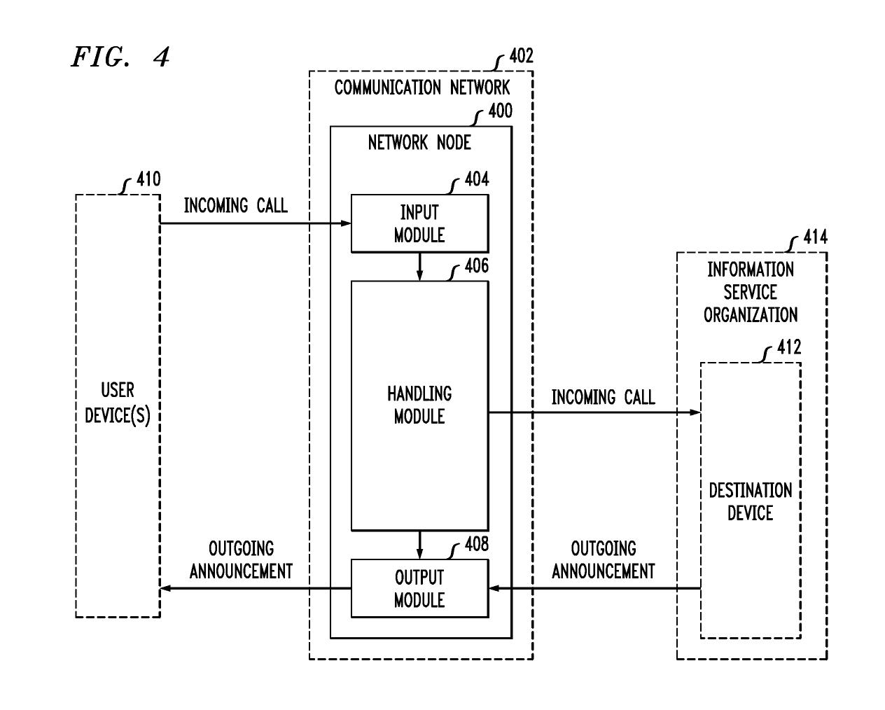

With reference to FIG. 4, an exemplary embodiment of a first network node 400 in a communication network 402 for disseminating information relating to a local emergency condition may include a first input module 404, a first handling module 406, and a first output module 408. The first network node 400 may provide at least a first user device 410 with access to an outgoing announcement via at least the first network node 400. The outgoing announcement may be accessible via a non-emergency network address associated with a destination device 412. The non-emergency network address may also be associated with an information service organization 414 that provides information service relating to local emergency conditions for a predetermined geographic area. The non-emergency network address may be distinct from an emergency network address associated with an emergency response organization that provides emergency response service for at least a portion of the predetermined geographic area. The outgoing announcement may provide select information for at least one local emergency condition within at least a portion of the predetermined geographic area.

The first input module 404 may receive a first incoming call originated by the first user device 410 and directed to the non-emergency network address. The first network node 400 and the first user device 410 may be located within the predetermined geographic area. The first handling module 406 may be operative communication with the first input module 404 and may connect the first incoming call to the destination device 412. The first output module 408 may be in operative communication with the first handling module 406 and may route the outgoing announcement from the destination device 412 to the first user device 410 through at least the first network node 400.

In another embodiment of the first network node 400, the first incoming call may include a voice call, a VoIP call, or any suitable type of call in any suitable combination. In yet another embodiment, the first network node 400 may include a circuit switching center, a MSC, a base station, a packet switching center, an ISP, a VoIP service provider, or any suitable type of network node. Of course, a given network node may include multiple types of network nodes in any suitable combination. For example, in one embodiment, the first network node 400 may include a serving network node serving user devices within at least a portion of the predetermined geographic area. In this embodiment, the serving network node may include the first input module 404, first handling module 406, and first output module 408.

In still another embodiment, the communication network 402 may include a ISP, a wireless telephone network, a cellular telephone network, a satellite telephone network, an IP network, a VoIP network, a LAN, a WAN, a MAN, or any suitable type of communication network in any suitable combination.

In still yet another embodiment, the first user device 410 may include a landline telephone, a wireless telephone, a cellular telephone, a satellite telephone, a portable computer device, a computer workstation, an IP telephone, or any suitable user device in any suitable combination. In another embodiment of the first network node 400, the non-emergency network address may include a SAC, a directory number, a telephone number, an IP address, or any suitable network address. Of course, a given network address may include multiple types of network addresses in any suitable combination.

In yet another embodiment, the destination device 412 may include an outgoing announcement system, an IVR system, an answering machine, a landline telephone, a wireless telephone, a cellular telephone, a satellite telephone, a portable computer device, a computer workstation, an IP telephone, or any suitable destination device in any suitable combination.

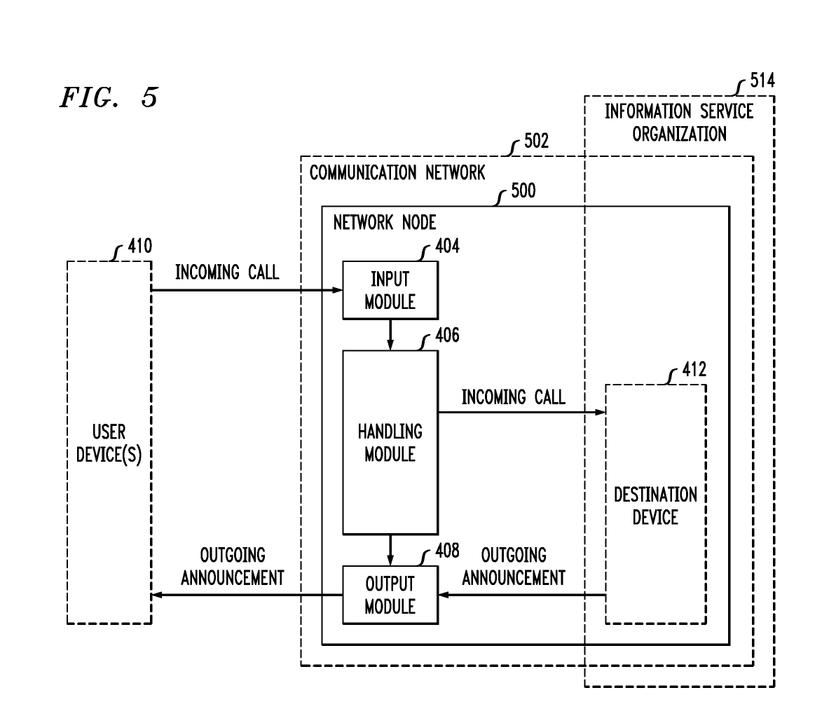

With reference to FIG. 5, another exemplary embodiment of a first network node 500 in a communication network 502 for disseminating information relating to a local emergency may include the first input module 404, first handling module 406, and first output module 408 of FIG. 4. In the embodiment being described, the first network node 500 may also include the destination device 412 of FIG. 1. In this embodiment, the first network node 500 interfaces with the first user device 410 of FIG. 1 and with an information service organization 514. The first input module 404, first handling module 406, first output module 408, first user device 410, and destination device 412 operate as described above in relation to FIG. 1. The first network node 500, communication network 502, and information service organization 514 operate similar to that which is described above for the first network node 400, communication network 402, and information service organization 414 in relation to FIG. 4. However, in this embodiment, the information service organization 514 overlaps the first network node 500 and communication network 502 because the destination device 412 is located within the first network node 500 as well as falling under the information service organization 514.

With reference again to FIG. 4, in still another embodiment of the first network node 400, the emergency network address may include a SAC, a directory number, a telephone number, an IP address, or any suitable network address. Of course, a given network address may include multiple types of network addresses in any suitable combination. In still yet another embodiment of the first network node 400, the emergency response organization includes a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In another embodiment, the information service organization 414 may include a private business entity, a public business entity, a government agency, a government executive organization, or any suitable business or government entity in any suitable combination. In yet another embodiment of the first network node 400, the select information provided in the outgoing announcement may include a status report for at least one local emergency condition within at least a portion of the predetermined geographic area and a guidance report with at least one response measure for each corresponding local emergency condition. In still another embodiment of the first network node 400, the outgoing announcement may be periodically updated during each corresponding local emergency condition to provide near real-time select information for each corresponding local emergency condition.

For example, in one embodiment, the outgoing announcement may be periodically updated during each corresponding local emergency condition in conjunction with source information from a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still yet another embodiment of the first network node 400, the outgoing announcement may be uninterruptible while the first incoming call is connected to the destination device 412. In another embodiment of the first network node 400, the outgoing announcement may include a one-way broadcast communication.

In yet another embodiment of the first network node 400, the outgoing announcement may include a pre-recorded message having a known duration. In the embodiment being described, the first output module 408 may continue to route the pre-recorded message to the first user device 410 until the first incoming call is ended by the first user device 410. Alternatively, for the embodiment being described, the first output module 408 may end the first incoming call after the pre-recorded message for the outgoing announcement routed to the first user device 410 is complete.

In another embodiment, the first network node 400 provides at least a second user device 410 with access to the outgoing announcement via at least the first network node 400. The first input module 410 may receive a second incoming call originated by the second user device 410 and directed to the non-emergency network address. The second user device 410 may be located within the predetermined geographic area. The first handling module 404 may bridge the second incoming call to the destination device 412. The first output module 408 may route the outgoing announcement from the destination device 412 to the second user device 410 through at least the first network node 400 in conjunction with routing the outgoing announcement to the first user device 410.

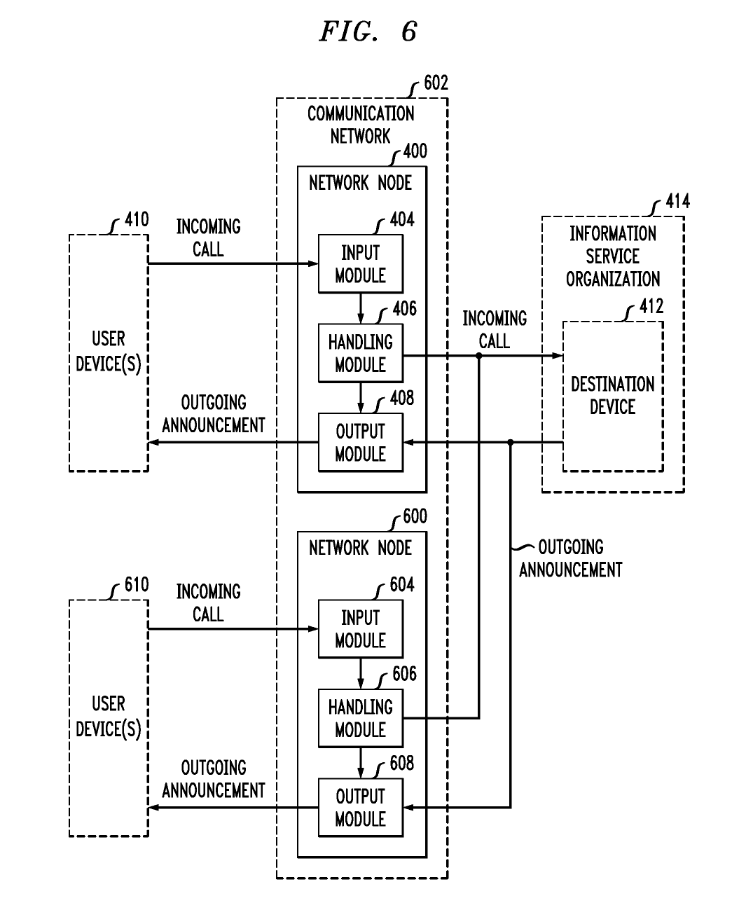

With reference to FIG. 6, an exemplary embodiment of a communication network 602 with multiple network nodes for disseminating information relating to a local emergency may include the first network node 400 of FIG. 4 and a second network node 600. The first network node 400 may include the first input module 404, first handling module 406, and first output module 408 of FIG. 4. The second network node 600 may include a first input module 604, a first handling module 606, and a first output module 608. In the embodiment being described, the first network node 400 interfaces with the first user device 410, destination device 412, and information service organization 414 of FIG. 1. Similarly, the second network node 600 interfaces with a second user device 610 and the destination device 412 and information service organization 414 of FIG. 1.

In this embodiment, the first network node 400, first input module 404, first handling module 406, first output module 408, first user device 410, destination device 412, and information service organization 414 operate as described above in relation to FIG. 1. The second network node 600, communication network 602, and second user device 610 operate similar to that which is described above for the first network node 400, communication network 402, and second user device 410 in relation to FIG. 4. However, in this embodiment, the communication network 602 includes first and second network nodes 400, 600.

In the embodiment being described, the second network node 600 in the communication network 602 may provide at least the second user device 610 with access to the outgoing announcement via at least the second network node 600. The second network node 600 may include a second input module 604, a second handling module 606, and a second output module 608. The second input module 604 may receive a second incoming call originated by the second user device 610 and directed to the non-emergency network address. The second network node 600 and the second user device 610 may be located within the predetermined geographic area. The second handling module 606 may be in operative communication with the second input module 604 and may bridge the second incoming call to the destination device 412. The second output module 608 may be in operative communication with the second handling module 606 and may route the outgoing announcement from the destination device 412 to the second user device 610 through at least the second network node 600 in conjunction with the first output module 408 routing the outgoing announcement to the first user device 410.

With reference again to FIG. 4, in another embodiment of the first network node 400, the outgoing announcement may include a pre-recorded message having a known duration and the pre-recorded message may be iteratively repeated over time. In the embodiment being described, the first handling module 406 may connect the first incoming call to the destination device 412 after a current iteration of the pre-recorded message is complete such that the outgoing announcement routed to the first user device 410 begins at a next iteration of the pre-recorded message. In this embodiment, the first network node 400 may provide at least a second user device 410 with access to the outgoing announcement via at least the first network node 400. The first input module 404 may receive a second incoming call originated by the second user device 410 and directed to the non-emergency network address. The second user device 410 may be located within the predetermined geographic area. The first handling module 406 may connect the second incoming call to the destination device 412 after the current iteration of the pre-recorded message is complete. The first output module 408 may route the outgoing announcement from the destination device 412 to the second user device 410 through at least the first network node 400 in conjunction with routing the outgoing announcement to the first user device 410 such that the outgoing announcement to the first and second user devices 410 begins at the next iteration of the pre-recorded message.

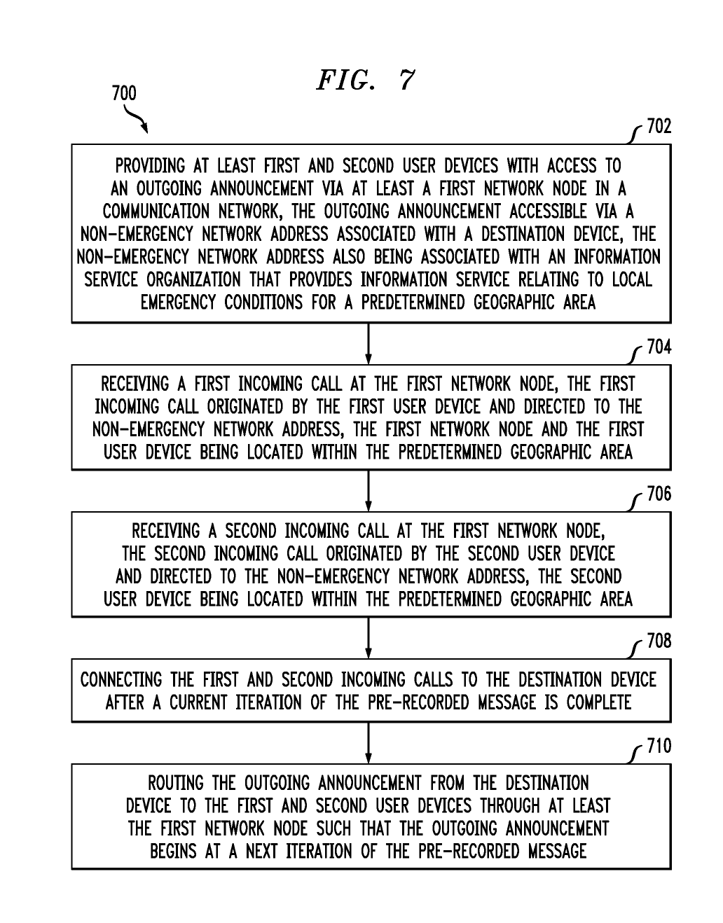

With reference to FIG. 7, still another exemplary embodiment of a process 700 for disseminating information relating to a local emergency condition begins at 702 where at least first and second user devices may be provided with access to an outgoing announcement via at least a first network node in a communication network. The outgoing announcement may be accessible via a non-emergency network address associated with a destination device. The non-emergency network address may also be associated with an information service organization that provides information service relating to local emergency conditions for a predetermined geographic area. The non-emergency network address may be distinct from an emergency network address associated with an emergency response organization that provides emergency response service for at least a portion of the predetermined geographic area. The outgoing announcement may include a pre-recorded message having a known duration and the pre-recorded message may be iteratively repeated over time. The pre-recorded message may provide select information for at least one local emergency condition within at least a portion of the predetermined geographic area.

At 704, a first incoming call may be received at the first network node. The first incoming call may be originated by the first user device and directed to the non-emergency network address. The first network node and the first user device may be located within the predetermined geographic area. Next, a second incoming call may be received at the first network node (706). The second incoming call may be originated by the second user device and directed to the non-emergency network address. The second user device may be located within the predetermined geographic area. At 708, the first and second incoming calls may be connected to the destination device after a current iteration of the pre-recorded message is complete. Next, the outgoing announcement may be routed from the destination device to the first and second user devices through at least the first network node such that the outgoing announcement begins at a next iteration of the pre-recorded message (710).

In another embodiment of the process 700, each of the first and second incoming calls may include a voice call, a VoIP call, or any suitable type of call in any suitable combination. In yet another embodiment of the process 700, the first network node may include a circuit switching center, a MSC, a base station, a packet switching center, an ISP, a VoIP service provider, or any suitable type of network node. Of course, a given network node may include multiple types of network nodes in any suitable combination. For example, in one embodiment, the first network node may include a serving network node serving user devices within at least a portion of the predetermined geographic area.

In still another embodiment of the process 700, the communication network may include a ISP, a wireless telephone network, a cellular telephone network, a satellite telephone network, an IP network, a VoIP network, a LAN, a WAN, a MAN, or any suitable type of communication network in any suitable combination.

In still yet another embodiment of the process 700, each of the first and second user devices may include a landline telephone, a wireless telephone, a cellular telephone, a satellite telephone, a portable computer device, a computer workstation, an IP telephone, or any suitable user device in any suitable combination. In another embodiment of the process 700, the non-emergency network address may include a SAC, a directory number, a telephone number, an IP address, or any suitable network address. Of course, a given network address may include multiple types of network addresses in any suitable combination.

In yet another embodiment of the process 700, the destination device may include an outgoing announcement system, an IVR system, an answering machine, a landline telephone, a wireless telephone, a cellular telephone, a satellite telephone, a portable computer device, a computer workstation, an IP telephone, or any suitable destination device in any suitable combination. For example, in one embodiment, the destination device may be located within the first network node.

In still another embodiment of the process 700, the emergency network address may include a SAC, a directory number, a telephone number, an IP address, or any suitable network address. Of course, a given network address may include multiple types of network addresses in any suitable combination. In still yet another embodiment of the process 700, the emergency response organization may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In another embodiment of the process 700, the information service organization may include a private business entity, a public business entity, a government agency, a government executive organization, or any suitable business or government entity in any suitable combination. In yet another embodiment of the process 700, the select information provided in the outgoing announcement may include a status report for at least one local emergency condition within at least a portion of the predetermined geographic area and a guidance report with at least one response measure for each corresponding local emergency condition. In still another embodiment of the process 700, the outgoing announcement may be periodically updated during each corresponding local emergency condition to provide near real-time select information for each corresponding local emergency condition.

For example, in one embodiment, the outgoing announcement may be periodically updated during each corresponding local emergency condition in conjunction with source information from a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still yet another embodiment of the process 700, the outgoing announcement may be uninterruptible while at least one of the first and second incoming calls are connected to the destination device. In another embodiment of the process 700, the outgoing announcement may include a one-way broadcast communication.

In yet another embodiment, the process 700 include repeating 710 for the first incoming call until the first incoming call is ended by the first user device and repeating 710 for the second incoming call until the second incoming call is ended by the second user device. Alternatively, for the embodiment being described, the process 700 may include ending the first and second incoming calls after the pre-recorded message for the outgoing announcement in 710 is complete.

In still another embodiment, the process 700 may also include providing at least a third user device with access to the outgoing announcement via at least the first network node. In this embodiment, a third incoming call may be received at the first network node. The third incoming call may be originated by the third user device and directed to the non-emergency network address. The third user device may be located within the predetermined geographic area. In the embodiment being described, the third incoming call may be connected to the destination device after the current iteration of the pre-recorded message is complete. In this embodiment, the outgoing announcement may be routed from the destination device to the third user device through at least the first network node in conjunction with the routing in 710.

In still yet another embodiment, the process 700 may also include providing at least a third user device with access to the outgoing announcement via at least a second network node in the communication network. In this embodiment, a third incoming call may be received at the second network node. The third incoming call may be originated by the third user device and directed to the non-emergency network address. The second network node and the third user device may be located within the predetermined geographic area. In the embodiment being described, the third incoming call may be connected to the destination device after the current iteration of the pre-recorded message is complete. In this embodiment, the outgoing announcement may be routed from the destination device to the third user device through at least the second network node in conjunction with the routing in 710.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for disseminating information relating to a local emergency condition, comprising:
a) providing at least a first user device with access to an outgoing announcement via at least a first network node in a communication network, the outgoing announcement accessible via a non-emergency network address associated with a destination device, the non-emergency network address also being associated with an information service organization that provides information service relating to local emergency conditions for a predetermined geographic area, wherein the non-emergency network address is distinct from an emergency network address associated with an emergency response organization that provides emergency response service for at least a portion of the predetermined geographic area, wherein the outgoing announcement provides select information for at least one local emergency condition within at least a portion of the predetermined geographic area;
b) receiving a first incoming call at the first network node, the first incoming call originated by the first user device and directed to the non-emergency network address, the first network node and the first user device being located within the predetermined geographic area;
c) connecting the first incoming call to the destination device; and
d) routing the outgoing announcement from the destination device to the first user device through at least the first network node.

2. The method of claim 1 wherein the select information provided in the outgoing announcement includes a status report for at least one local emergency condition within at least a portion of the predetermined geographic area and a guidance report with at least one response measure for each corresponding local emergency condition.

3. The method of claim 1 wherein the outgoing announcement is periodically updated during each corresponding local emergency condition to provide near real-time select information for each corresponding local emergency condition.

4. The method of claim 1 wherein the outgoing announcement is uninterruptible while the first incoming call is connected to the destination device.

5. The method of claim 1 wherein the outgoing announcement comprises a one-way broadcast communication.

6. The method of claim 1 wherein the outgoing announcement includes a pre-recorded message having a known duration, the method further comprising:
e) repeating d) until the first incoming call is ended by the first user device.

7. The method of claim 1 wherein the outgoing announcement includes a pre-recorded message having a known duration, the method further comprising:
e) ending the first incoming call after the pre-recorded message for the outgoing announcement in d) is complete.

8. The method of claim 1, further comprising:
e) providing at least a second user device with access to the outgoing announcement via at least the first network node;
f) receiving a second incoming call at the first network node, the second incoming call originated by the second user device and directed to the non-emergency network address, the second user device being located within the predetermined geographic area;
g) bridging the second incoming call to the destination device; and
h) routing the outgoing announcement from the destination device to the second user device through at least the first network node in conjunction with the routing in d).

9. The method of claim 1, further comprising:
e) providing at least a second user device with access to the outgoing announcement via at least a second network node in the communication network;
f) receiving a second incoming call at the second network node, the second incoming call originated by the second user device and directed to the non-emergency network address, the second network node and the second user device being located within the predetermined geographic area;
g) bridging the second incoming call to the destination device; and
h) routing the outgoing announcement from the destination device to the second user device through at least the second network node in conjunction with the routing in d).

10. The method of claim 1 wherein the outgoing announcement includes a pre-recorded message having a known duration and the pre-recorded message is iteratively repeated over time, wherein the connecting in b) is after a current iteration of the pre-recorded message is complete such that the outgoing announcement for the routing in c) begins at a next iteration of the pre-recorded message.

11. The method of claim 10, further comprising:
e) providing at least a second user device with access to the outgoing announcement via at least the first network node;
f) receiving a second incoming call at the first network node, the second incoming call originated by the second user device and directed to the non-emergency network address, the second user device being located within the predetermined geographic area;
g) connecting the second incoming call to the destination device after the current iteration of the pre-recorded message is complete; and
h) routing the outgoing announcement from the destination device to the second user device through at least the first network node in conjunction with the routing in d) such that the outgoing announcement to the first and second user devices begins at the next iteration of the pre-recorded message.

12. An apparatus for disseminating information relating to a local emergency condition, comprising:
a first network node in a communication network for providing at least a first user device with access to an outgoing announcement via at least the first network node, the outgoing announcement accessible via a non-emergency network address associated with a destination device, the non-emergency network address also being associated with an information service organization that provides information service relating to local emergency conditions for a predetermined geographic area, wherein the non-emergency network address is distinct from an emergency network address associated with an emergency response organization that provides emergency response service for at least a portion of the predetermined geographic area, wherein the outgoing announcement provides select information for at least one local emergency condition within at least a portion of the predetermined geographic area, the first network node comprising:
a first input module for receiving a first incoming call originated by the first user device and directed to the non-emergency network address, the first network node and the first user device being located within the predetermined geographic area;
a first handling module in operative communication with the first input module for connecting the first incoming call to the destination device; and
a first output module in operative communication with the first handling module for routing the outgoing announcement from the destination device to the first user device through at least the first network node.

13. The apparatus of claim 12 wherein the first network node comprises a serving network node serving at least a portion of the predetermined geographic area, the serving network node comprising the first input module, first handling module, and first output module.

14. The apparatus of claim 12, the first network node further comprising the destination device.

15. The apparatus of claim 12 wherein the first network node provides at least a second user device with access to the outgoing announcement via at least the first network node, the first input module receiving a second incoming call originated by the second user device and directed to the non-emergency network address, the second user device being located within the predetermined geographic area, the first handling module bridging the second incoming call to the destination device, and the first output module routing the outgoing announcement from the destination device to the second user device through at least the first network node in conjunction with routing the outgoing announcement to the first user device.

16. The apparatus of claim 12, further comprising:
a second network node in the communication network for providing at least a second user device with access to the outgoing announcement via at least the second network node, the second network node comprising:
a second input module for receiving a second incoming call originated by the second user device and directed to the non-emergency network address, the second network node and the second user device being located within the predetermined geographic area;
a second handling module in operative communication with the second input module for bridging the second incoming call to the destination device; and
a second output module in operative communication with the second handling module for routing the outgoing announcement from the destination device to the second user device through at least the second network node in conjunction with the first output module routing the outgoing announcement to the first user device.

17. The apparatus of claim 12 wherein the outgoing announcement includes a pre-recorded message having a known duration and the pre-recorded message is iteratively repeated over time;
wherein the first handling module connects the first incoming call to the destination device after a current iteration of the pre-recorded message is complete such that the outgoing announcement routed to the first user device begins at a next iteration of the pre-recorded message;
wherein the first network node provides at least a second user device with access to the outgoing announcement via at least the first network node, the first input module receiving a second incoming call originated by the second user device and directed to the non-emergency network address, the second user device being located within the predetermined geographic area, the first handling module connecting the second incoming call to the destination device after the current iteration of the pre-recorded message is complete, and the first output module routing the outgoing announcement from the destination device to the second user device through at least the first network node in conjunction with routing the outgoing announcement to the first user device such that the outgoing announcement to the first and second user devices begins at the next iteration of the pre-recorded message.

18. A method for disseminating information relating to a local emergency condition, comprising:
a) providing at least first and second user devices with access to an outgoing announcement via at least a first network node in a communication network, the outgoing announcement accessible via a non-emergency network address associated with a destination device, the non-emergency network address also being associated with an information service organization that provides information service relating to local emergency conditions for a predetermined geographic area, wherein the non-emergency network address is distinct from an emergency network address associated with an emergency response organization that provides emergency response service for at least a portion of the predetermined geographic area, wherein the outgoing announcement includes a pre-recorded message having a known duration and the pre-recorded message is iteratively repeated over time, wherein the pre-recorded message provides select information for at least one local emergency condition within at least a portion of the predetermined geographic area;
b) receiving a first incoming call at the first network node, the first incoming call originated by the first user device and directed to the non-emergency network address, the first network node and the first user device being located within the predetermined geographic area;
c) receiving a second incoming call at the first network node, the second incoming call originated by the second user device and directed to the non-emergency network address, the second user device being located within the predetermined geographic area;
d) connecting the first and second incoming calls to the destination device after a current iteration of the pre-recorded message is complete; and
e) routing the outgoing announcement from the destination device to the first and second user devices through at least the first network node such that the outgoing announcement begins at a next iteration of the pre-recorded message.

19. The method of claim 18, further comprising:
f) providing at least a third user device with access to the outgoing announcement via at least the first network node;
g) receiving a third incoming call at the first network node, the third incoming call originated by the third user device and directed to the non-emergency network address, the third user device being located within the predetermined geographic area;
h) connecting the third incoming call to the destination device after the current iteration of the pre-recorded message is complete; and
i) routing the outgoing announcement from the destination device to the third user device through at least the first network node in conjunction with the routing in e).

20. The method of claim 18, further comprising:
f) providing at least a third user device with access to the outgoing announcement via at least a second network node in the communication network;
g) receiving a third incoming call at the second network node, the third incoming call originated by the third user device and directed to the non-emergency network address, the second network node and the third user device being located within the predetermined geographic area;
h) connecting the third incoming call to the destination device after the current iteration of the pre-recorded message is complete; and
i) routing the outgoing announcement from the destination device to the third user device through at least the second network node in conjunction with the routing in e).
